(19) United States
(12) Patent Application Publication
(10) Pub. No.: US 2025/0208981 A1
(43) Pub. Date: Jun. 26, 2025

(54) SYSTEMS AND METHODS FOR GENERATING TEST CONTENT

(71) Applicant: Comcast Cable Communications, LLC, Philadelphia, PA (US)

(72) Inventors: Philip John STROFFOLINO, Media, PA (US); Arthur JOST, Mount Laurel, NJ (US)

(21) Appl. No.: 18/390,847

(22) Filed: Dec. 20, 2023

(51) Int. Cl. G06F 11/36

(52) U.S. Cl. CPC G06F 11/3684; G06F 11/3698

(57) ABSTRACT

Methods and systems for generating test content are disclosed. To analyze or test output of a content item, test content that shares the same characteristics as the content item may be generated using generic (e.g., public domain) video and/or audio. Because the test content shares the same characteristics as the content item, the test content may be used to analyze or test the output of the content item. But because the test content is generated using generic video and/or audio, the test content is not subject to restrictions that limit or prevent its use in the testing environments.

### BACKGROUND

Content items are commonly associated with one or more restrictions. The one or more restrictions may comprise digital rights management (DRM) authorizations, geo-blocking, whitelisting, expired certificates, copyright restrictions, and/or objectionable content. Content items that are associated with such restriction(s) may be unsuitable for use as test content (e.g., content that is used to test output devices). Therefore, improved techniques for generating test content are desirable.

### SUMMARY

Methods, systems, and devices for generating test content are disclosed. Users may experience playback issues (e.g., glitching, freezing, noise, etc.) when viewing certain content streams. To identify the underlying cause of such issues, the problematic content streams may need be tested in a testing environment. However, the problematic content streams may be associated with restrictions that limit or prevent their use in testing environments. Test content that shares the same characteristics (e.g., unique content encoding or packaging variations) as the problematic content streams may be generated using generic (e.g., public domain) video and/or audio. The characteristics of the problematic content streams may be determined using their corresponding manifest files. The generic video and/or audio may be transcoded based on the characteristics. Because the test content shares the same characteristics as the problematic content streams, the test content may be used to identify the cause of the issues associated with the problematic content streams. But because the test content is generated using generic video and/or audio, the test content is not subject to restrictions that limit or prevent its use in the testing environments.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example system.

FIG. 3 is an example method.

FIG. 4 is an example method.

FIG. 5 is an example method.

FIG. 6 is an example computing device.

### DETAILED DESCRIPTION OF ILLUSTRATIVE EMBODIMENTS

Methods and systems for generating test content are disclosed. Output devices (e.g., content output devices, media players, playback devices, etc.) may need to be tested, such as during development of the output devices and/or to debug the output devices. To test an output device, production content (e.g., content produced for distribution to viewers, content streams, production streams, etc.) may be output via the output device in a controlled lab environment. A tester (e.g., human tester, user, computing process etc.) may view the output of the production content via the output device to identify a cause of one or more errors associated with output of the production content via that particular type of output device. Based on identifying the cause of the error(s), the tester may remedy the error(s).

However, production content may be associated with one or more restrictions. A content item may be associated with digital rights management (DRM) restricting the use, modification, and/or distribution of the content item. A content item may be associated with geo-blocking that restricts access to the content item based on geographical location. A content item may be associated with whitelisting that restricts access to the content item to a list of approved devices, entities, or users. A content item may be associated with one or more expired certificates, copyright restrictions, and/or objectionable (e.g., adult) content. These restrictions may make it challenging to use the content as test content.

To avoid violating the restrictions commonly associated with content, pre-made test content may instead be used to test output devices. However, pre-made test content ages quickly and often does not adequately represent the actual characteristics (e.g., encoding characteristics, packaging characteristics, etc.) of production content. To avoid violating the restrictions commonly associated with production content, a set of production content items that are authorized for testing purposes may be collected and stored for future playback. However, even if an output device is authorized to output a production content item, the decryption keys necessary for outputting the production content item may expire quickly (e.g., within a timeframe of a few hours or days), thus rendering the production content item useless for testing. Further, copyright may limit the distribution of the production content items to other labs and partners for share investigations, and objectionable (e.g., adult) production content may be inappropriate for use in a controlled lab environment. As such, improved techniques for generating test content are desirable.

Described herein are techniques for generating test content (e.g., test patterns, public domain content). The characteristics of a production content item may be determined. The characteristics may comprise one or more of a manifest structure, fragment durations and timing information, codecs, bitrate/chunk sizes, and/or the like. The characteristics may be determined using the manifest file(s) associated with the production content item and/or the header data associated with the production content item. As such, the characteristics may be determined without violating any of the restrictions to which the production content item is subject. A test content item that shares the characteristics of the production content item may be generated using generic (e.g., public domain, arbitrary) video and/or audio. The characteristics of the problematic content streams may be determined using their corresponding manifest files and/or header data. The generic video and/or audio may be transcoded based on the characteristics. The test content item may not be associated with any of the restrictions to which the original production content item was subject. The test content item may be freely used and shared, such as for testing output devices.

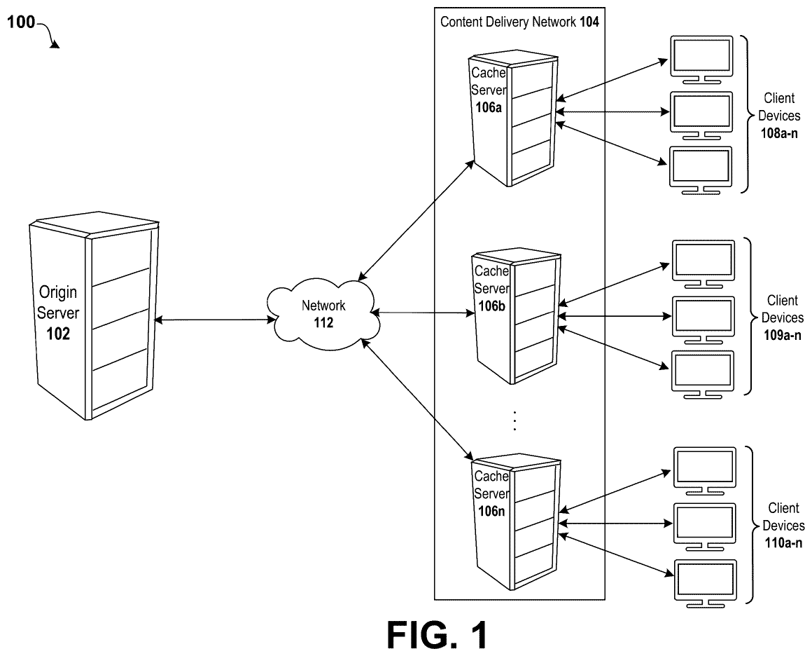

FIG. 1 shows a block diagram of an example system 100. The system 100 may comprise an origin server 102. The origin server 102 may be configured to transmit data (e.g., video data, audio data, or other types of data) to a content delivery network (CDN) 104 comprising one or more cache servers 106a-n. A client device (e.g., client devices 108a-n, 109a-n, and/or 110a-n) may request one or more data objects (e.g., a manifest file and/or video segments/fragments) from a corresponding one of the cache servers 106a-n, such as when the client device initiates a video stream. If the cache server has already requested the data object, it may transmit that to the requesting client device. If the cache server has not already requested the data object, the cache server may proxy or relay the request to the origin server 102, which may respond by transmitting the data object to the cache server. The cache server, in turn, may transmit the data object to the requesting client device.

The origin server 102 may generally comprise one or more computing devices configured to process and respond to incoming requests for data (e.g., video data or other data relating to video delivery). The origin server 102 may refer to a single computing device or may refer collectively to two or more networked computing devices. External data storage accessible to the origin server 102, such as network-attached storage (NAS) or in a storage area network (SAN), may be considered as part of the origin server 102.

It is generally contemplated in the context of a CDN that data requests to the origin server 102 come from the cache servers 106 rather than clients 108 to minimize the total number of requests to the origin server 102 and provide better response latency, although the disclosure is not so limited. The origin server 102 may store data, such as the data requested by the client devices. The origin server 102 may store data associated with an adaptive bitrate video stream, such as multiple versions or profiles (e.g., with respect to bitrate) of the video content of the stream. The origin server 102 may also store data adjunct to video data, such as associated manifest files, header data, authentication data, or website data (e.g., HTML, CSS, image, or script files). Such data may be stored at the origin server 102 or may be stored in external storage, such as network-attached storage (NAS) or in a storage area network (SAN). The origin server 102 may serve as a source for live video content and may transmit encoded video data as it is transcoded from a live video feed. This live video data may be considered as being stored at the origin server 102. The origin server 102 may comprise a “point of packaging” for a video stream.

The origin server 102 may be associated with a content distribution entity. For example, the origin server 102 may be associated with a multichannel video programming distributor (MVPD), such as a cable or satellite television provider system. The origin server 102 may be associated with a video streaming entity, such as a subscription-based video streaming platform or a video sharing/hosting platform. As another example, the origin server 102 may be associated with an audio streaming entity, such as a subscription-based or ad-supported audio streaming platform. As the disclosure is not limited to video data, the origin server 102 may be associated more generally with any digital content provider or publisher.

The client devices (e.g., client devices 108a-n, 109a-n, and/or 110a-n) may request for and receive a manifest file or the like that is associated with a video stream. The client device may request the video data of the video stream according to the manifest file. The client devices (e.g., client devices 108a-n, 109a-n, and/or 110a-n) may each comprise any one of numerous types of devices configured to receive video data and decode the received video data for viewer consumption. The client devices (e.g., client devices 108a-n, 109a-n, and/or 110a-n) may each comprise a display device, such as a television display. A client device may comprise a computing device, such as a laptop computer or a desktop computer. A client device may comprise a mobile device, such as a smart phone or a tablet computer. A client device may be configured to receive video data and output the video data to a separate display device for consumer viewing. For example, a client device may comprise a set-top box, such as a cable set-top box. A set-top box may receive video data via a cable input (e.g., co-axial cable or fiber optic cable) and format the received video data for output to a display device. A set-top box may receive video data via digital video streaming. A client device may comprise a digital video recorder (DVR) that receives and stores video data for later viewing.

The network 112 may comprise a private portion. The network 112 may comprise a public portion, such as the Internet. The network 112 may comprise a content distribution and/or access network. The network 112 may comprise a cable television network or a content delivery network. The network 112 may facilitate communication via one or more communication protocols. The network 112 may comprise fiber, cable, or a combination thereof. The network 112 may comprise wired links, wireless links, a combination thereof, and/or the like. The network 112 may comprise routers, switches, nodes, gateways, servers, modems, and/or the like.

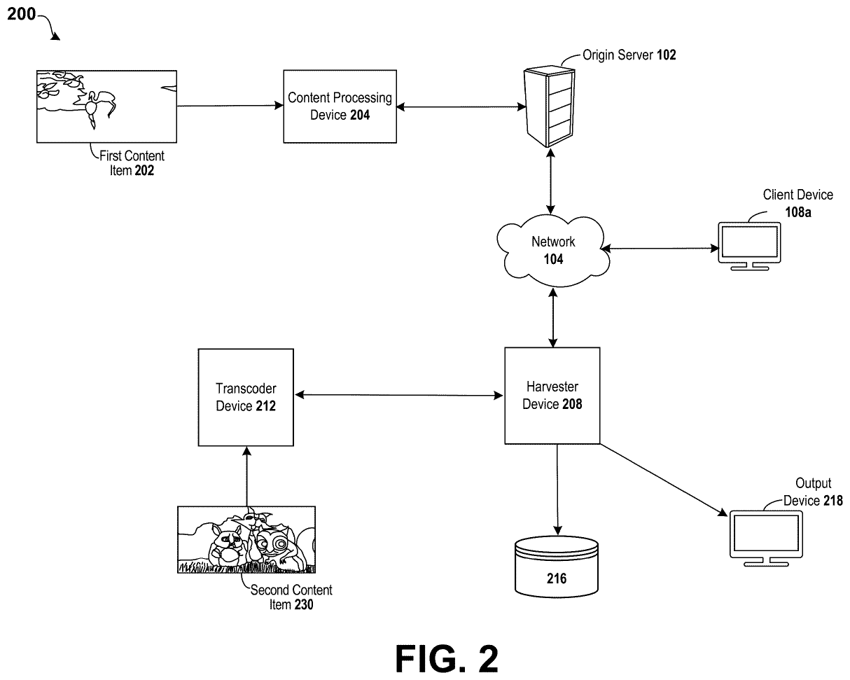

FIG. 2 illustrates an example system 200. The system 200 may be used to generate test content. The system 200 may comprise a content processing device 204, the origin server 102, the client device 108a, a harvester device 208, a transcoder device 212, a storage device 216, and an output device 218. It should be noted that while the singular term device is used herein, it is contemplated that some devices may be implemented as a single device or a plurality of devices (e.g., via load balancing).

As described above with regard to FIG. 1, the origin server 102 may be configured to distribute content, such as a first content item 202, to client devices (e.g., the client device 108a) via one or more cache servers. The client device 108a may request the first content item 202. The first content item 202 may comprise a production content item. The first content item 202 may comprise one or more of linear content, non-linear content, video-on-demand (VoD) content, live VoD content, audio content, multi-media content, recorded content, stored content, or any other form of content a user may wish to consume. Video content may refer generally to any video content produced for viewer consumption regardless of the type, format, genre, or delivery method. Video content may comprise video content produced for broadcast via over-the-air radio, cable, satellite, or the internet. Video content may comprise a movie, a television show or program, an episodic or serial television series, or a documentary series, such as a nature documentary series. The first content item 202 may comprise a song, a television show, a live broadcast, a movie, a podcast, an audio book, or any other type of content a user may wish to consume.

A content processing device 204 may process the first content item 202. The content processing device 204 may comprise an encoder. The encoder may encode the uncompressed first content item 202. The first content item 202 may be encoded in any one of a variety of formats, such as, for example, H.264, MPEG-4 Part 2, or MPEG-2. The encoder may convert the first content item 202 from one video format to another video format, such as one format compatible with the output devices of the service provider's users (e.g., client device 108a). The encoder may comprise any type of encoder including but not limited to: H.264/MPEG-AVC, H.265/MPEG-HEVC, MPEG-5 EVC, H.266/MPEG-VVC, AV1, VP9, Global motion compensation (GMC), etc. The encoder may transcode the first content item 202 into one or more output streams. The one or more output streams may comprise video encoded with different resolutions and/or different bit rates.

The content processing device 204 may comprise a packager (e.g., linear packager). The packager may receive the first content item 202 from the encoder. The packager may determine how the first content item 202 is to be segmented and/or fragmented and put together for delivery to and eventual playback by client devices, such as the client device 108a. As part of this process, the packager may segment and/or fragment the first content item 202 or may re-segment/re-fragment the first content item 202. The packager may additionally insert one or more cues or markers into the segment and/or fragments of the first content item 202 at which one or more additional segment and/or fragments, such as segment and/or fragments comprising an advertisement, may be inserted, such as by an upstream client, server, or logical module.

Each of the segment and/or fragments may be associated with one or more headers (e.g., header data, container level headers). The header(s) may comprise a styp box. The styp box may comprise data (e.g., information) indicating a type of media segments (e.g., audio, video, or text) associated with the corresponding segment and/or fragment. The styp box may comprise data (e.g., information) indicating the version of the codecs used. The data contained in the styp box may be used by client devices to understand the format of the corresponding segment and/or fragment and to decode the segment and/or fragment correctly. The header(s) may comprise a moof box. The moof box may comprise metadata associated with the corresponding segment and/or fragment. If the first content item is a linear content item, the header(s) may comprise a prft box. The prft box may comprise data indicating times corresponding to the production of the corresponding segment and/or fragment. If the first content item is a linear content item, the header(s) may comprise an emsg box. The emsg box may comprise data (e.g., information) indicating in-band media timed events associated with the corresponding segment and/or fragment, such as Society of Cable and Telecommunications (SCTE) 35 cue messages, callback, or media presentation description (MPD) Validity Expiration events.

The packager may generate one or more adaptive bit rate (ABR) streams of the first content item 202 in different ABR streaming formats. Each of the one or more adaptive bit rate (ABR) streams may be associated with a particular profile (e.g., version) of the first content item 202. Each of the one or more ABR streams may comprise segments and/or fragments of the first content item 202. The content processing device 204 may be configured to apply one or more DRM restrictions to one or more of the ABR streams. The content processing device 204 may be configured to add subtitles and/or multiple audio languages to one or more of the ABR streams. The packager may send the one or more ABR streams and/or the corresponding profiles to the origin server 102 for storage.

The first content item 202 may be associated with one or more manifest files. The one or more manifest files may comprise one or more of a sliding manifest file (e.g., if the first content item 202 is a linear content item), a fixed manifest file (e.g., if the first content item 202 is a VoD content item), or a growing manifest (e.g., if the first content item 202 is a live VOD content item). The origin server 102 and/or the content processing device 204 may generate the manifest file(s) associated with the first content item 202. The origin server 102 may store the manifest file(s) associated with the first content item 202.

The manifest file(s) may comprise information describing various aspects of the associated ABR stream that may be useful for the client devices (e.g., the client device 108a) to playback the first content item 202. The manifest file(s) may comprise information indicative of an availability of each of the one or more ABR streams, the segments and/or fragments associated with the one or more ABR streams, the length of each segment and/or fragment, the number of segments and/or fragments, the proper ordering of the segments and/or fragments necessary to cause playback of the first content item 202, and/or information for requesting the segments and/or fragments (e.g., via a URL). The manifest file(s) may comprise a network location (e.g., a hyper-text transfer protocol (HTTP) uniform resource locater (URL) link or other universal resource identifier (URI)) for each segment and/or fragment from which the segment and/or fragment may be downloaded, accessed, or retrieved.

The manifest file(s) may comprise information indicative of one or more characteristics of the first content item 202. If each of the segments and/or fragments is associated with a corresponding manifest file, each manifest file may comprise information indicative of one or more characteristics of the corresponding segment and/or fragment of the first content item 202. The characteristic(s) may comprise at least one of a duration of the segment and/or fragment of the first content item 202, a chunk size associated with the segment and/or fragment of the first content item 202, a video resolution of the segment and/or fragment of the first content item 202, an audio sampling of the segment and/or fragment of the first content item 202, a bit rate associated with the segment and/or fragment of the first content item 202, a video codec associated with the segment and/or fragment of the first content item 202, or supplemental content insertion cues associated with the segment and/or fragment of the first content item 202.

The manifest file(s) may be sent, such as by the origin server 102, to the client device 108a in response to a request from the client device 108a to receive the first content item 202. The client device 108a may use the manifest file(s) to determine the segments and/or fragments required to play the first content item 202 and request the required segments and/or fragments using the network locations specified in the manifest file. The origin server 102 may send the segments and/or fragments of the first content item 202 to the client device 108a. The client device 108a may receive the segments and/or fragments of the first content item 202 and cause output (e.g., display, playback) of the segments and/or fragments.

The first content item 202 may be associated with one or more restrictions. The first content item 202 may be associated with a DRM authorization restricting the use, modification, and/or distribution of the first content item 202. The first content item 202 may be associated with geo-blocking that restricts access to the first content item 202 based on geographical location. The first content item 202 may be associated with whitelisting that restricts access to the first content item 202 to a list of approved devices, entities, or users. The first content item 202 may be associated with one or more expired certificates, copyright restrictions, and/or objectionable (e.g., adult) content. These restrictions may make it challenging to use the first content item 202 as test content.

Test content that that has similar characteristics (e.g., manifest structure, segment and/or fragment durations and timing information, codecs, bitrate/chunk sizes, etc.) to the first content item 202 may be generated. The test content item may be generated using generic (e.g., public domain, arbitrary) video and/or audio. Generating the test content item using generic video and/or audio, may ensure that the test content item is not associated with any of the restrictions to which the first content item 202 was subject. The test content item may be freely used and shared, such as for testing output devices.

The origin server 102 may send the manifest file(s) associated with the first content item 202 to a harvester device 208. The origin server 102 may send the segments and/or fragments of the first content item 202 to the harvester device 208. The origin server 102 may send the manifest file(s) and/or the segments/fragments of the first content item 202 to the harvester device 208 via the network 104. The harvester device 208 may receive the manifest file(s) and/or the segments/fragments of the first content item 202. The harvester device 208 may receive the manifest file(s) and/or the segments/fragments based on (e.g., in response to) requesting the segments of the first content item 202. The harvester device 208 may receive the manifest file(s) and/or the segments/fragments based on (e.g., in response to) requesting all available bit rates, formats, representations, and/or adaptation sets of the first content item 202. The manifest file(s) and/or the segments/fragments may be sent (e.g., manually or automatically) to the harvester device 208 in response to any other condition being satisfied. The condition may comprise the detection of a network condition, the detection of a playback condition, receipt of an error or complaint associated with playback of the first content item, and/or the like.

The harvester device 208 may not cause output (e.g., playback) of the first content item 202 based on receiving the manifest file(s) and/or the segments/fragments. The harvester device 208 may determine characteristic data associated with each segment and/or fragment of the first content item 202. The harvester device 208 may determine characteristic data associated with each segment and/or fragment of the first content item 202 for each profile (e.g., version) of the first content item 202. The harvester device 208 may determine the characteristic data based at least on the manifest file(s). The harvester device 208 may determine the characteristic data associated with a particular segment and/or fragment of the first content item 202 based on the header data of that particular segment and/or fragment of the first content item 202. The harvester device 208 may determine the characteristic data associated with a particular segment and/or fragment of the first content item 202 based on the data included in the corresponding styp box, moof box, prft box, and/or emsg box. The harvester device 208 may send the characteristic data to a transcoder device 212 and/or may use the characteristic data to configure or control the transcoder device 212 (e.g., to transcode a second content item 230 based on the characteristic data).

The characteristic data associated with a particular segment and/or fragment of the first content item 202 may indicate one or more characteristics associated with that segment and/or fragment. The one or more characteristics may comprises at least one of a duration of the segment and/or fragment of the first content item 202, a chunk size associated with the segment and/or fragment of the first content item 202, a video resolution of the segment and/or fragment of the first content item 202, an audio sampling of the segment and/or fragment of the first content item 202, a bit rate associated with the segment and/or fragment of the first content item 202, a video codec associated with the segment and/or fragment of the first content item 202, or supplemental content insertion cues associated with the segment and/or fragment of the first content item 202.

Using the manifest file(s) and/or the header data associated with the first content item 202 to determine the characteristic(s) associated with the first content item 202 may enable determination of the characteristic(s) without violating restrictions to which the first content item 202 may be subject. The fragments and/or segments of the first content item 202 may be encrypted. Determining the characteristic(s) associated with the first content item 202 using the manifest file(s) and/or header data may comprise determining the characteristic(s) without decrypting the fragments and/or segments of the first content item 202.

The transcoder device 212 may receive the characteristic data. The transcoder device 212 may receive the characteristic data associated with each profile (e.g., version) of the first content item 202. The transcoder device 212 may receive the characteristic data from the harvester device 108. The transcoder device 212 may receive a second content item 230. The second content item 230 may comprise generic (e.g., public domain, arbitrary) video and/or audio. The second content item 230 may not be associated with a DRM authorization restricting the use, modification, and/or distribution of the second content item 230. The second content item 230 may not be associated with geo-blocking that restricts access to the second content item 230 based on geographical location. The second content item 230 may not be associated with whitelisting that restricts access to the second content item 230 to a list of approved devices, entities, or users. The second content item 230 may not be associated with one or more expired certificates, copyright restrictions, and/or objectionable (e.g., adult) content.

The transcoder device 212 may transcode the second content item 230 based on the characteristic data. The transcoder device 212 may transcode the second content item 230 based on the characteristic data on a fragment-by-fragment (or segment-by-segment) basis. The transcoder device 212 may transcode a version of the second content item 230 associated with each profile (e.g., version) of the first content item 202 based on the corresponding characteristic data. The transcoder device 212 may transcode a first fragment and/or segment of the second content item 230 based on the characteristic data associated with a first fragment and/or segment of the first content item 202, a second fragment and/or segment of the second content item 230 based on the characteristic data associated with a second fragment and/or segment of the first content item 202, and so on. The transcoded second content item may be associated with the same characteristics (e.g., manifest structure, fragment durations and timing information, codecs, bitrate/chunk sizes, etc.) as the first content item 202.

Transcoding the second content item 230 based on the characteristic data may comprise generating one or more encoding parameters based on the characteristic data. The second content item 230 may be transcoded based on the one or more encoding parameters. The transcoder device 212 may generate one or more encoding parameters associated with the first fragment and/or segment of the second content item 230 based on the characteristic data associated with the first fragment and/or segment of the first content item 202. The transcoder device 212 may encode the first fragment and/or segment of the second content item 230 based on the one or more encoding parameters. The transcoder device 212 may repeat this process for each fragment and/or segment of the second content item 230. The transcoder device 212 may send the transcoded second content item fragments and/or segments to the harvester device 208.

The encoding parameters of the transcoder device 212 may be configured (e.g., by the harvester device 208 and/or by the transcoder device 212) to match the same video and/or audio encoding parameters that were used by the content processing device 204 to encode the first content item 202. Each of the encoding parameters of the transcoder device 212 may correspond to one of fragment duration, resolution, target bit rate, codec to be used, presentation timestamp (PTS) values, etc. The transcoder device 212 may use the configured parameters to encode the video and/or audio of second content item 230. This process may be repeated for each profile (e.g., version) of the first content item 202.

The transcoded second content item may share the same characteristics as the first content item 202 but may not be associated with any of the restrictions to which the first content item 202 was subject. Because the transcoded second content emulates the characteristics of the first content item 202, the transcoded second content may be used for purposes of analyzing the first content item 202, devices, and/or a content delivery system.

The harvester device 208 may receive the transcoded second content item fragments and/or segments. The harvester device 208 may store the transcoded second content item fragments and/or segments, such as in a database 216. The stored transcoded second content item fragments and/or segments may be used for testing purposes. Output of the stored transcoded second content item fragments and/or segments may be caused to analyze and/or troubleshoot the first content item 202 and/or to analyze and/or troubleshoot an output device. For example, output of the stored transcoded second content item fragments and/or segments may be caused to facilitate inspection of implementation problems associated with the output device, such as implementation problems related to transcoding and/or delivery of content. Output of the transcoded second content item fragments and/or segments may be caused to evaluate one or more output devices, such as by performing regression tests after refactoring the one or more output devices. Output of the transcoded second content item fragments and/or segments may be caused to determine a cause of at least one error associated with the first content item 202.

The harvester device 208 may cause real-time output (e.g., via the output device 218) of the transcoded second content item fragments and/or segments for testing purposes. Real-time output of the transcoded second content item fragments and/or segments may be caused to analyze the first content item 202 and/or to analyze the output device in real time (e.g., during output of the first content item 202 via a client device). For example, real-time output of the transcoded second content item fragments and/or segments may be caused to determine a cause of at least one error associated with the first content item 202 in real time (e.g., during output of the first content item 202 via a client device).

The output device 218 may comprise a physical computing device, such as a set-top box. A tester (e.g., human tester, user, computing process etc.) may view output of the second content item fragments and/or segments via the output device 210 to analyze the first content item 202 and/or to analyze the output device 218 (e.g., a type of output device corresponding to the output device 218). The output device 218 may comprise a virtualized device. The virtualized device may perform the virtualization for a variety of devices with different features to analyze the first content item 202 and/or to analyze the output device 218.

Analyzing the first content item 202 may comprise testing playback of the first content item 202, attempting to recreate errors associated with output of the first content item 202, and/or identifying the cause of one or more errors associated with output of the first content item 202. The error(s) may comprise an error associated with processing a fragment and/or segment of the first content item 202. The error(s) may comprise an error associated with playback (e.g., output, display, rendering) of a fragment and/or segment of the first content item 202. The error associated with playback of the fragment and/or segment of the first content item 202 may be associated with freezing, jittering, and/or macro blocking during playback of the fragment and/or segment of the first content item 202. The error(s) may comprise an error associated with a type of device causing output of a fragment and/or segment of the first content item 202. The error(s) may comprise an error associated with transmission of a fragment and/or segment of the first content item 202. The error(s) may comprise an error associated with delivery of a fragment and/or segment of the first content item 202. The error(s) may comprise an error associated with a network configured to deliver a fragment and/or segment of the first content item 202 to one or more output devices. Using the transcoded second content item fragments and/or segments to analyze the first content item 202 may allow the first content item 202 to be analyzed without violating any of the restrictions to which the first content item 202 is subject. Analyzing the output device 218 may comprise debugging the output device 218 or verifying proper operation of the output device 218. Using the transcoded second content item fragments and/or segments to analyze the output device 218 may allow the output device 218 to be analyzed without violating any of the restrictions to which the first content item 202 is subject.

The transcoded second content item fragments and/or segments may be associated with text. The transcoder device 212 may be configured to encode, into the video image, textual information about the characteristics (e.g., bit rate, resolution, timestamp, etc.). The text may indicate the one or more characteristics of the first content item 202 that were used to transcode the second content item 230. If the transcoded second content item fragments and/or segments are associated with text, output of the transcoded second content item fragments and/or segments may cause output of the text. Thus, a user that is viewing the output second content item fragments and/or segments may easily be able to identify the characteristics associated with the second content item fragments and/or segments. Being able to easily be able to identify the characteristics associated with the second content item fragments and/or segments may make it easier for the user to analyze the first content item 202 and/or analyze the output device 218.

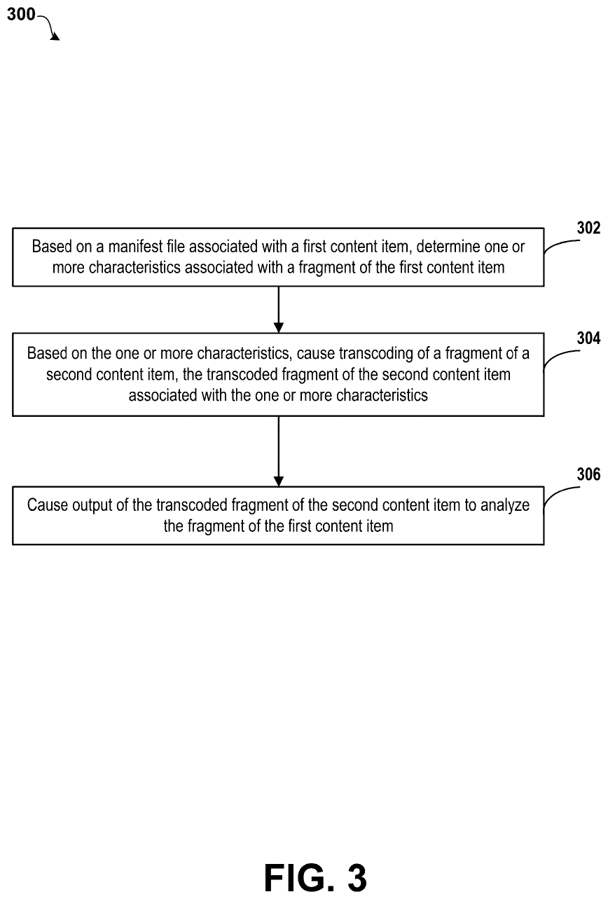

FIG. 3 is an example method 300. The method 300 may comprise a computer implemented method for generating test content. A system and/or computing environment, such as the system 200 of FIG. 2, may be configured to perform the method 300. For example, the harvester device 208 of FIG. 2 may be configured to perform the method 300.

A first content item may be associated with a DRM authorization restricting the use, modification, and/or distribution of the first content item. The first content item may be associated with geo-blocking that restricts access to the first content item based on geographical location. The first content item may be associated with whitelisting that restricts access to the first content item to a list of approved devices, entities, or users. The first content item may be associated with one or more expired certificates, copyright restrictions, and/or objectionable (e.g., adult) content. These restrictions may make it challenging to test output devices in a controlled lab environment using the first content item.

At 302, one or more characteristics associated with a fragment of the first content item may be determined. The first content item may comprise a linear (e.g., live) content item. The first content item may comprise a non-linear content item. The one or more characteristics associated with a fragment of the first content item may be determined based at least on a manifest file associated with the first content item. The manifest file may be associated with an adaptive bitrate streaming (ABR) profile. Determining the one or more characteristics associated with the fragment of the first content item may comprise determining the one or more characteristics based on header data associated with the fragment of the first content item. The fragment of the first content item may be encrypted. Determining the one or more characteristics associated with the fragment of the first content item may comprise determining the one or more characteristics without decrypting the fragment of the first content item.

The one or more characteristics may comprise at least one of a duration of the fragment of the first content item, a chunk size associated with the fragment of the first content item, a video resolution of the fragment of the first content item, an audio sampling of the fragment of the first content item, a bit rate associated with the fragment of the first content item, a video codec associated with the fragment of the first content item, or supplemental content insertion cues associated with the fragment of the first content item.

A second content item may comprise generic (e.g., public domain, arbitrary) video and/or audio. The second content item may not be associated with a DRM authorization restricting the use, modification, and/or distribution of the second content item. The second content item may not be associated with geo-blocking that restricts access to the second content item based on geographical location. The second content item may not be associated with whitelisting that restricts access to the second content item to a list of approved devices, entities, or users. The second content item may not be associated with one or more expired certificates, copyright restrictions, and/or objectionable (e.g., adult) content.

At 304, transcoding of a fragment of the second content item may be caused. The transcoding of the fragment of the second content item may be caused based on the one or more characteristics. The transcoded fragment of the second content item may be associated with the one or more characteristics. Causing transcoding of the fragment of the second content item may comprise causing generation of one or more encoding parameters. Causing generation of the one or more encoding parameters may be based on the one or more characteristics. Causing transcoding of the fragment of the second content item may comprise sending the one or more characteristics to a transcoder device configured to transcode the fragment of the second content item. The transcoder device may transcode the fragment of the second content item based on the one or more encoding parameters.

At 306, output of the transcoded fragment of the second content item may be caused. Output of the transcoded fragment of the second content item may be caused via one or more output devices. Causing the output of the transcoded fragment of the second content item may comprise at least one of causing storage of the transcoded fragment of the second content item for future output or causing real-time output of the transcoded fragment of the second content item.

The output (e.g., future output or real time output) of the transcoded fragment of the second content item may be associated with analyzing the first content item and/or analyzing the output device(s). The output (e.g., future output or real time output) of the transcoded fragment of the second content item may be caused to analyze the first content item and/or analyzing the output device(s). The output (e.g., future output or real time output) of the transcoded fragment of the second content item may be caused based on a process associated with analyzing the first content item and/or analyzing the output device(s). Analyzing the first content item may comprise analyzing the fragment of the first content item. Analyzing the first content item may comprise determining a cause of at least one error associated with the fragment of the first content item. The at least one error associated with the fragment of the first content item may comprise one or more of an error associated with processing the fragment of the first content item, an error associated with output (e.g., playback) of the fragment of the first content item, an error associated with a type of device causing output of the fragment of the first content item, an error associated with transmission of the fragment of the first content item, an error associated with delivery of the fragment of the first content item, or an error associated with a network configured to deliver the fragment of the first content item to one or more output devices. Analyzing the output device(s) may comprise debugging the output device(s) and/or verifying proper operation of the output device(s).

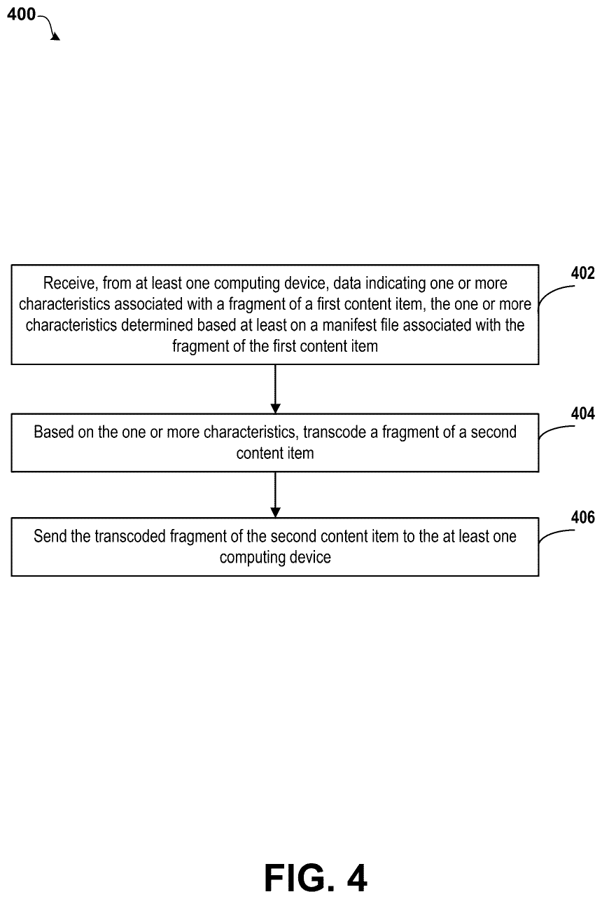

FIG. 4 is an example method 400. The method 400 may comprise a computer implemented method for generating test content. A system and/or computing environment, such as the system 200 of FIG. 2, may be configured to perform the method 400. For example, the transcoder device 212 of FIG. 2 may be configured to perform the method 400.

A first content item may be associated with a DRM authorization restricting the use, modification, and/or distribution of the first content item. The first content item may be associated with geo-blocking that restricts access to the first content item based on geographical location. The first content item may be associated with whitelisting that restricts access to the first content item to a list of approved devices, entities, or users. The first content item may be associated with one or more expired certificates, copyright restrictions, and/or objectionable (e.g., adult) content. These restrictions may make it challenging to test output devices in a controlled lab environment using the first content item.

At 402, data indicating one or more characteristics associated with a fragment of the first content item may be received. The data indicating one or more characteristics associated with the fragment of the first content item may be received at a transcoder device and from at least one computing device. The one or more characteristics may be determined based at least on a manifest file associated with the fragment of the first content item. The one or more characteristics may be determined based on header data associated with the fragment of the first content item. The fragment of the first content item may be encrypted. The one or more characteristics may be determined without decrypting the fragment of the first content item. The first content item may comprise a linear content item. The one or more characteristics may comprise at least one of a duration of the fragment of the first content item, a chunk size associated with the fragment, a video resolution of the fragment, an audio sampling of the fragment, a bit rate associated with the fragment, a video codec associated with the fragment, or supplemental content insertion cues associated with the fragment.

A second content item may comprise generic (e.g., public domain, arbitrary) video and/or audio. The second content item may not be associated with a DRM authorization restricting the use, modification, and/or distribution of the second content item. The second content item may not be associated with geo-blocking that restricts access to the second content item based on geographical location. The second content item may not be associated with whitelisting that restricts access to the second content item to a list of approved devices, entities, or users. The second content item may not be associated with one or more expired certificates, copyright restrictions, and/or objectionable (e.g., adult) content.

At 404, a fragment of the second content item may be transcoded. The fragment of the second content item may be transcoded based at least one the one or more characteristics. Transcoding the fragment of the second content item based on the characteristic data may comprise generating one or more encoding parameters based on the characteristic data. The fragment of the second content item may be transcoded based on the one or more encoding parameters. The transcoded fragment of the second content item may be associated with one or more overlays. The overlays may be configured to display information indicating the one or more characteristics associated with the profile. The transcoded fragment of the second content item may share the same characteristics as the fragment of the first content item but may not be associated with any of the restrictions to which the first content item was subject. As such, the transcoded fragment of the second content item may be freely used and shared, such as for testing output devices.

At 406, the transcoded fragment of the second content item may be sent to the at least one computing device (e.g., harvester device). The at least one computing device may receive the transcoded fragment of the second content item. The at least one computing device may store the transcoded fragment of the second content item, such as in a database. The stored transcoded fragment of the second content item may be used for testing purposes. Output of the stored transcoded fragment of the second content item may be caused to analyze the first content item and/or analyzing one or more output devices.

Output of the stored transcoded fragment of the second content item may be caused to determine a cause of at least one error associated with the first content item. The output (e.g., future output or real time output) of the transcoded fragment of the second content item may be associated with analyzing the first content item and/or analyzing the output device(s). The at least one computing device may cause real-time output of the transcoded fragment of the second content item for testing purposes. Real-time output of the transcoded fragment of the second content item may be caused to determine a cause of at least one error associated with the first content item in real time (e.g., during output of the first content item via a client device).

Using the transcoded fragment of the second content item to determine the cause of the error(s) associated with the first content item may allow the cause of the error(s) to be identified without violating any of the restrictions to which the first content item is subject. The error(s) may comprise one or more of an error associated with processing the fragment of the first content item, an error associated with playback (e.g., output, display, rendering) of the fragment of the first content item, an error associated with a type of device causing output of the fragment of the first content item, an error associated with transmission of the fragment of the first content item, an error associated with delivery of the fragment of the first content item, or an error associated with a network configured to deliver the fragment of the first content item to one or more output devices.

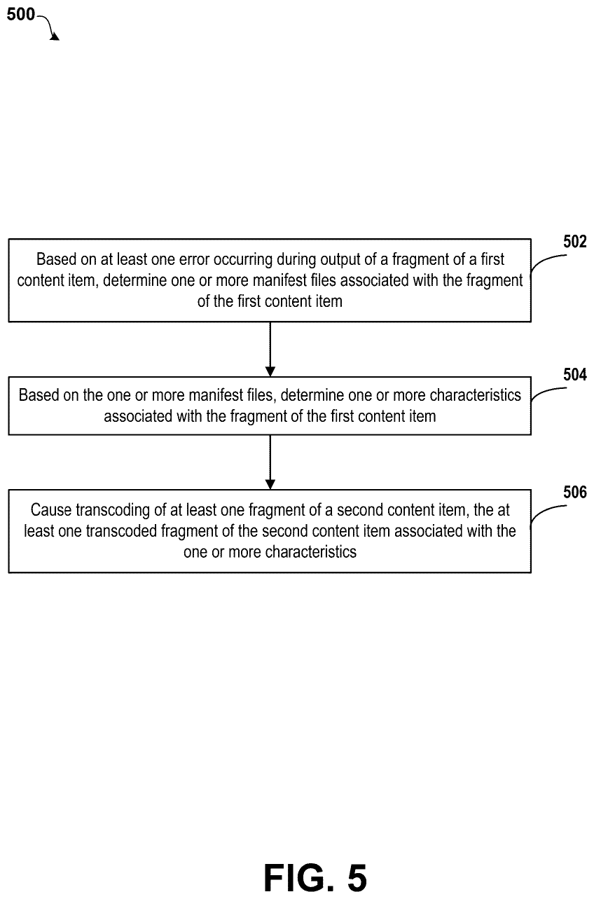

FIG. 5 is an example method 500. The method 500 may comprise a computer implemented method for generating test content. A system and/or computing environment, such as the system 200 of FIG. 2, may be configured to perform the method 500. For example, the harvester device 208 of FIG. 2 may be configured to perform the method 500.

A first content item may be associated with a DRM authorization restricting the use, modification, and/or distribution of the first content item. The first content item may be associated with geo-blocking that restricts access to the first content item based on geographical location. The first content item may be associated with whitelisting that restricts access to the first content item to a list of approved devices, entities, or users. The first content item may be associated with one or more expired certificates, copyright restrictions, and/or objectionable (e.g., adult) content. These restrictions may make it challenging to test output devices in a controlled lab environment using the first content item. The first content item may comprise a linear (e.g., live) content item.

At 502, one or more manifest files may be determined. The one or more manifest files may be associated with a fragment of the first content item. The one or more manifest files may be determined based on at least one error occurring during output of the fragment of the first content item. The error(s) may comprise one or more of an error associated with processing the fragment of the first content item, an error associated with playback (e.g., output, display, rendering) of the fragment of the first content item, an error associated with a type of device causing output of the fragment of the first content item, an error associated with transmission of the fragment of the first content item, an error associated with delivery of the fragment of the first content item, or an error associated with a network configured to deliver a fragment and/or segment of the first content item to one or more output devices.

At 504, one or more characteristics associated with the fragment of the first content item may be determined. The one or more characteristics may be determined based at least on the manifest file(s). The one or more characteristics associated with the fragment of the first content item may be determined based on header data associated with the fragment of the first content item. The fragment of the first content item may be encrypted. Determining the one or more characteristics associated with the fragment of the first content item may comprise determining the one or more characteristics without decrypting the fragment of the first content item.

The one or more characteristics may comprise at least one of a duration of the fragment of the first content item, a chunk size associated with the fragment of the first content item, a video resolution of the fragment of the first content item, an audio sampling of the fragment of the first content item, a bit rate associated with the fragment of the first content item, a video codec associated with the fragment of the first content item, or supplemental content insertion cues associated with the fragment of the first content item.

A second content item may comprise generic (e.g., public domain, arbitrary) video and/or audio. The second content item may not be associated with a DRM authorization restricting the use, modification, and/or distribution of the second content item. The second content item may not be associated with geo-blocking that restricts access to the second content item based on geographical location. The second content item may not be associated with whitelisting that restricts access to the second content item to a list of approved devices, entities, or users. The second content item may not be associated with one or more expired certificates, copyright restrictions, and/or objectionable (e.g., adult) content.

At 506, transcoding of a fragment of the second content item may be caused. The transcoding of the fragment of the second content item may be caused based on the one or more characteristics. The transcoded fragment of the second content item may be associated with the one or more characteristics. Causing transcoding of the fragment of the second content item may comprise causing generation of one or more encoding parameters. Causing generation of the one or more encoding parameters may be based on the one or more characteristics. Causing transcoding of the fragment of the second content item may comprise sending the one or more characteristics to a transcoder device configured to transcode the fragment of the second content item. The transcoder device may transcode the fragment of the second content item based on the one or more encoding parameters.

The transcoded fragment of the second content item may share the same characteristics as the fragment of the first content item but may not be associated with any of the restrictions to which the first content item was subject. As such, the transcoded fragment of the second content item may be freely used and shared, such as for testing output devices.

The method 500 may further comprise causing analysis of the at least one transcoded fragment of the second content item. The analysis may be caused to determine a cause of the at least one error. Causing analysis of the at least one transcoded fragment of the second content item may comprise storing the at least one transcoded fragment of the second content item, such as in a database. The stored at least one transcoded fragment of the second content item may be used for testing purposes. Output of the stored at least one transcoded fragment of the second content item may be caused to determine a cause of at least one error associated with the first content item. Causing analysis of the at least one transcoded fragment of the second content item may comprise causing real-time output (e.g., via an output device) of the at least one transcoded fragment of the second content item for testing purposes. Real-time output of the at least one transcoded fragment of the second content item may be caused to analyze the fragment of the first content item in real time. Analyzing the fragment of the first content item in real time may comprise determining a cause of at least one error associated with the first content item in real time (e.g., during output of the first content item via a client device).

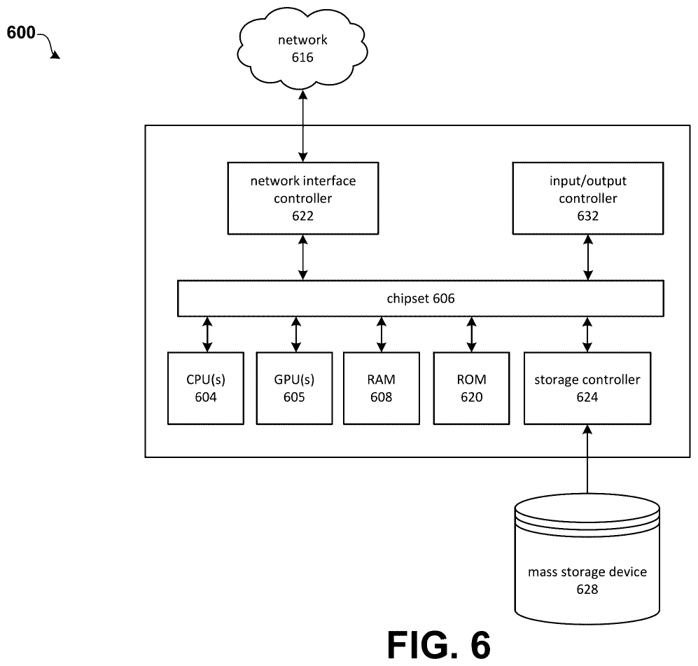

FIG. 6 depicts a computing device that may be used in various aspects, such as the servers and/or devices depicted in FIGS. 1-2. With regard to the example architecture of FIGS. 1-2, any of the components or devices in FIGS. 1-2 may each be implemented in an instance of a computing device 600 of FIG. 6.

The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
based on a manifest file associated with a first content item, determining one or more characteristics associated with a fragment of the first content item;
based on the one or more characteristics, causing transcoding of a fragment of a second content item, wherein the transcoded fragment of the second content item is associated with the one or more characteristics; and
causing output of the transcoded fragment of the second content item to analyze the fragment of the first content item.

2. The method of claim 1, wherein the fragment of the first content item is encrypted, and wherein determining the one or more characteristics associated with the fragment of the first content item comprises determining the one or more characteristics without decrypting the fragment of the first content item.

3. The method of claim 1, wherein determining the one or more characteristics associated with the fragment of the first content item comprises determining the one or more characteristics based on header data associated with the fragment of the first content item.

4. The method of claim 1, wherein the one or more characteristics comprises at least one of a duration of the fragment of the first content item, a chunk size associated with the fragment of the first content item, a video resolution of the fragment of the first content item, an audio sampling of the fragment of the first content item, a bit rate associated with the fragment of the first content item, a video codec associated with the fragment of the first content item, or supplemental content insertion cues associated with the fragment of the first content item.

5. The method of claim 1, wherein causing transcoding of the fragment of the second content item comprises:
based on the one or more characteristics, causing generation of one or more encoding parameters; and
based on the one or more encoding parameters, causing transcoding of the fragment of the second content item.

6. The method of claim 1, further comprising at least one of causing storage of the transcoded fragment of the second content item or causing real-time output of the transcoded fragment of the second content item.

7. The method of claim 1, wherein the manifest file is associated with an adaptive bitrate streaming (ABR) profile.

8. The method of claim 1, wherein analyzing the fragment of the first content item comprises determining a cause of at least one error associated with the first fragment of the content item, the at least one error comprising one or more of:
an error associated with processing the fragment of the first content item;
an error associated with playback of the fragment of the first content item;
an error associated with a type of device causing output of the fragment of the first content item;
an error associated with transmission of the fragment of the first content item;
an error associated with delivery of the fragment of the first content item; or
an error associated with a network configured to deliver the fragment of the first content item to one or more output devices.

9. The method of claim 1, wherein the first content item comprises a linear content item.

10. A method comprising:
receiving, at a transcoder device and from at least one computing device, data indicating one or more characteristics associated with a fragment of a first content item, and wherein the one or more characteristics are determined based at least on a manifest file associated with the fragment of the first content item;
based on the one or more characteristics, transcoding a fragment of a second content item; and
sending the transcoded fragment of the second content item to the at least one computing device.

11. The method of claim 10, wherein the fragment of the first content item is encrypted, and wherein the one or more characteristics are determined without decrypting the fragment of the first content item.

12. The method of claim 10, wherein the one or more characteristics are determined based on header data associated with the fragment of the first content item.

13. The method of claim 10, wherein the one or more characteristics comprises at least one of a duration of the fragment of the first content item, a chunk size associated with the fragment, a video resolution of the fragment, an audio sampling of the fragment, a bit rate associated with the fragment, a video codec associated with the fragment, or supplemental content insertion cues associated with the fragment.

14. The method of claim 10, wherein the transcoded fragment of the second content item is associated with one or more overlays configured to display information indicating the one or more characteristics.

15. The method of claim 10, wherein the first content item comprises a linear content item.

16. A method comprising:
based on at least one error occurring during output of a fragment of a first content item, determining one or more manifest files associated with the fragment of the first content item;
based on the one or more manifest files, determining one or more characteristics associated with the fragment of the first content item; and
causing transcoding of at least one fragment of a second content item, wherein the at least one transcoded fragment of the second content item is associated with the one or more characteristics.

17. The method of claim 16, further comprising causing analysis of the at least one transcoded fragment of the second content item to determine a cause of the at least one error.

18. The method of claim 16, wherein the at least one error comprises one or more of:
an error associated with processing the fragment of the first content item;
an error associated with playback of the fragment of the first content item;
an error associated with a type of device causing output of the fragment of the first content item;
an error associated with transmission of the fragment of the first content item;
an error associated with delivery of the fragment of the first content item; or
an error associated with a network configured to deliver the fragment of the first content item to one or more output devices.

19. The method of claim 16, wherein the one or more characteristics comprises at least one of a duration of the fragment of the first content item, a chunk size associated with the fragment of the first content item, a video resolution of the fragment of the first content item, an audio sampling of the fragment of the first content item, a bit rate associated with the fragment of the first content item, a video codec associated with the fragment of the first content item, or supplemental content insertion cues associated with the fragment of the first content item.

20. The method of claim 16, wherein determining the one or more characteristics associated with the fragment of the first content item comprises determining the one or more characteristics based on header data associated with the fragment of the first content item.
